(19) United States
(12) Patent Application Publication
(10) Pub. No.: US 2016/0147381 A1
(43) Pub. Date: May 26, 2016

(54) ELECTRONIC DEVICE AND METHOD OF CONTROLLING DISPLAY OF INFORMATION

(71) Applicant: BlackBerry Limited, Waterloo (CA)

(72) Inventor: Alan James ALPERT, Redwood City, CA (US)

(21) Appl. No.: 14/555,421

(22) Filed: Nov. 26, 2014

(51) Int. Cl. G06F 3/0482; G06F 3/0484

(52) U.S. Cl. CPC G06F 3/0482; G06F 3/04842

(57) ABSTRACT

A method of controlling display of information includes arranging tiles in a plurality of columns, each tile having a width of about a column width or about one half the column width, receiving a selection of a first tile and receiving a selection of a second tile. In response to determining that a first tile width is generally equal to a second tile width, exchanging locations of the first tile with the second tile. In response to determining that the first tile width is not equal to the second tile width, the smaller of the tiles is grouped with an adjacent tile from the same column. The locations of the grouped tiles and the remaining one of the selected tiles are exchanged.

### FIELD OF TECHNOLOGY

The present disclosure relates to electronic devices including, but not limited to, portable electronic devices and controlling the display of information.

### BACKGROUND

Electronic devices, including portable electronic devices, have gained widespread use and may provide a variety of functions including, for example, telephonic, electronic messaging and other personal information manager (PIM) application functions. Portable electronic devices include several types of devices including mobile stations such as simple cellular telephones, smart telephones (smart phones), Personal Digital Assistants (PDAs), tablet computers, and laptop computers, with wireless network communications or near-field communications connectivity such as Bluetooth® capabilities.

Portable electronic devices such as PDAs, or tablet computers are generally intended for handheld use and ease of portability. Handheld devices are relatively small and have limited space for user input and output.

Tiles are suitable for displaying information such as icons or widgets on a display and such tiles facilitate the use of a large percentage of the display for such information. Tiles may be displayed in various sizes to accommodate the display of the widget or icon information within the associated tile.

Improvements in electronic devices and the display of information are desirable.

### BRIEF DESCRIPTION OF THE DRAWINGS

Embodiments of the present disclosure will now be described, by way of example only, with reference to the attached figures, in which:

FIG. 1 is a block diagram of an example of a portable electronic device in accordance with the disclosure;

FIG. 2 is a front view of an example of a portable electronic device including information arranged in tiles arranged on a display thereof in accordance with the disclosure;

FIG. 3 is a flowchart illustrating a method of controlling display of information on the portable electronic device of FIG. 1 in accordance with the disclosure;

FIG. 4 through FIG. 11 illustrate examples of displayed information and control of the displayed information in accordance with the flowchart of FIG. 3; and

FIG. 12 and FIG. 13 illustrate an example of displayed information and control of the displayed information in accordance with the disclosure.

### DETAILED DESCRIPTION

The following describes an electronic device and a method of controlling display of information in tiles on an electronic device. The method includes arranging the tiles in a plurality of columns, each of the tiles having a width of about a column width or about one half the column width, receiving a selection of a first tile at a first location and receiving a selection of a second tile at a second location, and in response to determining that a first tile width is generally equal to a second tile width, exchanging the first tile with the second tile such that the first tile is moved generally to the second location and the second tile is moved generally to the first location. In response to determining that the first tile width is not equal to the second tile width and the first tile width is equal to about one half the column width the first tile is grouped with a first adjacent tile from a first adjacent location in a same one of the plurality of columns as the first tile, and the grouped first tile and first adjacent tile are exchanged with the second tile by moving the first tile and the first adjacent tile generally to the second location and the second tile generally to the first location and the first adjacent location. In response to determining that the first tile width is not equal to the second tile width and the second tile width is equal to about one half the column width, the second tile is grouped with a second adjacent tile from a second adjacent location in a same one of the plurality of columns as the second tile, and the first tile is exchanged with the grouped second tile and the second adjacent tile by moving the first tile generally to the second location and the second adjacent location and moving the second tile and second adjacent tile generally to the first location.

For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

The disclosure generally relates to an electronic device, such as a portable electronic device as described herein. Examples of electronic devices include mobile, or handheld, wireless communication devices such as cellular phones, cellular smart-phones, wireless organizers, personal digital assistants, wirelessly enabled notebook computers, tablet computers, mobile internet devices, electronic navigation devices, and so forth.

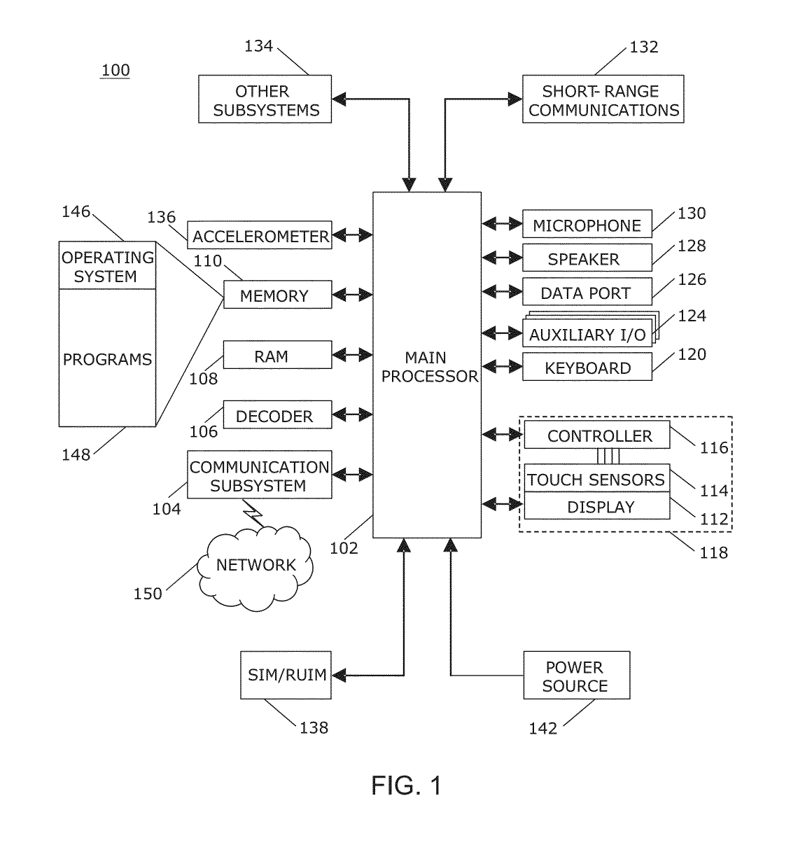

A block diagram of an example of an electronic device 100, which in the present example is a portable electronic device, is shown in FIG. 1. The electronic device 100 includes multiple components, such as a processor 102 that controls the overall operation of the electronic device 100. Communication functions, including data and voice communications, are performed through a communication subsystem 104. Data received by the electronic device 100 is decompressed and decrypted by a decoder 106. The communication subsystem 104 receives messages from and sends messages to a wireless network 150. The wireless network 150 may be any type of wireless network, including, but not limited to, data wireless networks, voice wireless networks, and networks that support both voice and data communications. A power source 142, such as one or more rechargeable batteries or a port to an external power supply, powers the electronic device 100.

The processor 102 interacts with other components, such as a Random Access Memory (RAM) 108, memory 110, a touch-sensitive display 118, a keyboard 120, an auxiliary input/output (I/O) subsystem 124, a data port 126, a speaker 128, a microphone 130, short-range communications 132 and other device subsystems 134. The speaker 128, also referred to as an earpiece speaker, is utilized to output audible signals when a user's ear is very close to the speaker 128. Although not shown, the processor may also interact with a loudspeaker, for example, for handsfree use. The keyboard 120 includes a plurality of keys, which may be mechanical keys that include mechanical switches or contacts for input to the electronic device 100 when a mechanical key of the keyboard is depressed by a sufficient amount to oppose a bias of the mechanical key. Alternatively, or in addition, the keys of the keyboard may include touch sensors coupled to a controller to detect touch input thereon.

The touch-sensitive display 118 includes a display 112 and touch sensors 114 that are coupled to at least one controller 116 that is utilized to interact with the processor 102. Input via a graphical user interface is provided via the touch-sensitive display 118. Information, such as text, characters, symbols, images, icons, and other items that may be displayed or rendered on a portable electronic device, is displayed on the touch-sensitive display 118 via the processor 102. The processor 102 may also interact with an accelerometer 136 that may be utilized to detect direction of gravitational forces or gravity-induced reaction forces.

To identify a subscriber for network access, the electronic device 100 may utilize a Subscriber Identity Module or a Removable User Identity Module (SIM/RUIM) card 138 for communication with a network, such as the wireless network 150. Alternatively, user identification information may be programmed into memory 110.

The electronic device 100 includes an operating system 146 and software programs, applications, or components 148 that are executed by the processor 102 and are typically stored in a persistent, updatable store such as the memory 110. Additional applications or programs may be loaded onto the electronic device 100 through the wireless network 150, the auxiliary I/O subsystem 124, the data port 126, the short-range communications subsystem 132, or any other suitable subsystem 134.

A received signal such as a text message, an e-mail message, or web page download is processed by the communication subsystem 104 and input to the processor 102. The processor 102 processes the received signal for output to the display 112 and/or to the auxiliary I/O subsystem 124. A subscriber may generate data items, for example e-mail messages, which may be transmitted over the wireless network 150 through the communication subsystem 104. For voice communications, the overall operation of the electronic device 100 is similar. The speaker 128 outputs audible information converted from electrical signals, and the microphone 130 converts audible information into electrical signals for processing.

The touch-sensitive display 118 may be any suitable touch-sensitive display, such as a capacitive touch-sensitive display that includes a plurality of capacitive touch sensors 114. Capacitive touch sensors 114 include drive electrodes, also known as transmission electrodes, and sense electrodes, also known as receive electrodes. The drive electrodes generally extend in one direction and cross over or under the sense electrodes, which generally extend in another direction, generally at right angles to the direction that the drive electrodes extend, to form a grid pattern. The drive electrodes are spaced from the sense electrodes by a dielectric material. The points at which the drive electrodes and the sense electrodes cross each other are referred to as nodes. The drive and sense electrodes may comprise any suitable material, such as indium tin oxide (ITO).

One or more touches, also known as touch contacts or touch events, may be detected by the touch-sensitive display 118. The processor 102 may determine attributes of the touch, including a location of the touch. Touch location data may include data for an area of contact or data for a single point of contact, such as a point at or near a center of the area of contact. The location of a detected touch may include x and y components, e.g., horizontal and vertical components, respectively, with respect to one's view of the touch-sensitive display 118. A touch may be detected from any suitable input member, such as a finger, thumb, appendage, or other objects, for example, a stylus, pen, or other pointer, depending on the nature of the touch-sensitive display 118. Multiple simultaneous touches may be detected.

By repeatedly scanning the electrodes of the touch-sensitive display 118 to detect touches, one or more gestures may also be detected by the touch-sensitive display 118. A gesture, such as a swipe, also known as a flick, is a particular type of touch on a touch-sensitive display 118 and may begin at an origin point and continue to an end point, for example, a concluding end of the gesture. A gesture may be identified by attributes of the gesture, including the origin point, the end point, the distance travelled, the duration, the velocity, and the direction, for example. A gesture may be long or short in distance and/or duration. Two points of the gesture may be utilized to determine a direction of the gesture. A gesture may also include a hover. A hover may be a touch at a location that is generally unchanged over a period of time or is associated with the same selection item for a period of time.

The touch-sensitive display 118 includes a display area in which information may be displayed, and a non-display area extending around the periphery of the display area. Information is not displayed in the non-display area by the display. The non-display area is utilized to accommodate, for example, electronic traces or electrical connections, adhesives or other sealants, and/or protective coatings around the edges of the display area. The non-display area may be referred to as an inactive area and is not part of the physical housing or frame of the electronic device. Typically, no pixels of the display are in the non-display area, thus no image can be displayed by the display 112 in the non-display area. Optionally, a secondary display, not part of the primary display 112, may be disposed in the non-display area. Touch sensors including drive electrodes and sense electrodes may be disposed in the non-display area, which touch sensors may be extended from the touch sensors in the display area or may be distinct or separate touch sensors from the touch sensors in the display area. A touch, including a gesture, may be associated with, i.e., performed on, the display area, the non-display area, or both areas. The touch sensors including the drive electrodes and the sense electrodes may extend across substantially the entire non-display area or may be disposed in only part of the non-display area.

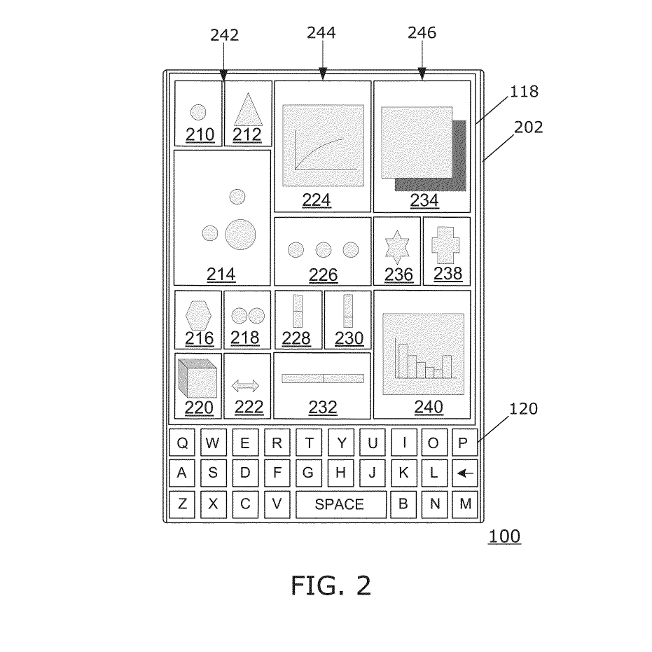

An example of an electronic device 100 is shown in FIG. 2. In the example of FIG. 2, the electronic device 100 includes a housing 202 in which the touch-sensitive display 118 is disposed. The housing 202 is utilized to enclose components such as the components shown in FIG. 1. The keyboard 120 is disposed below the touch-sensitive display 118 in the orientation illustrated in FIG. 2.

For the purpose of the example of FIG. 2, information 204 is displayed in tiles 210, 212, 214, 216, 218, 220, 222, 224, 226, 228, 230, 232, 234, 236, 238, 240 on the touch-sensitive display 118 of the electronic device 100. The tiles 210, 212, 214, 216, 218, 220, 222, 224, 226, 228, 230, 232, 234, 236, 238, 240 may be displayed, for example, as a home screen of the electronic device 100, or in response to receipt of a selection to display the tiles. The information may be any suitable information. For example, the information may be icons for selection of an application and related information, documents stored on or available from the electronic device 100, webpages that are bookmarked or frequently accessed, widgets, for display of information such as electronic device status information, sports scores or related information, weather reports, flight status, any other suitable information and any suitable combination of such information.

The tiles are arranged in columns. In this example, three columns 242, 244, 246 of tiles are displayed. The left column 242 includes 7 tiles 210, 212, 214, 216, 218, 220, 222. The middle column 244 includes five tiles 224, 226, 228, 230, 232, and the right column 246 includes four tiles 234, 236, 238, 240. Each column has an associated column width. Other numbers of columns and other numbers of tiles may be successfully implemented. Each tile is displayed in a column such that no tile is displayed across columns or in more than one column.

The width of each of the tiles is based on the width of the columns and is constrained such that each tile has a width that is either equal to about one half a column width or to about one column width. Thus tiles may have a width of about the column width or a width of about one half the column width. For each tile that is about one half column width, such as the tile 210, another tile of about one half column width is disposed adjacent and in the same column, such as the tile 212. The tiles that are about one half the column width, for example, may be slightly smaller than one half the column width to accommodate a space between adjacent tiles in the same column that have a width of about one half column width.

The terms left and right are utilized herein to refer to the location of rows relative to the orientation of the electronic device 100 illustrated in FIG. 2 and are not otherwise limiting.

The displayed height of the tiles 210, 212, 214, 216, 218, 220, 222, 224, 226, 228, 230, 232, 234, 236, 238, 240 may be constrained to a set height, may be constrained based on the tile width, or may be any suitable height, for example, for displaying the information on the tile. In the present example, the displayed height of the tiles 210, 212, 216, 218, 220, 220, 228, 230, 236, 238 that are about one half column width is constrained to one unit in height. The displayed height of the remaining tiles is constrained to any one of one unit in height, two units in height, or three units in height.

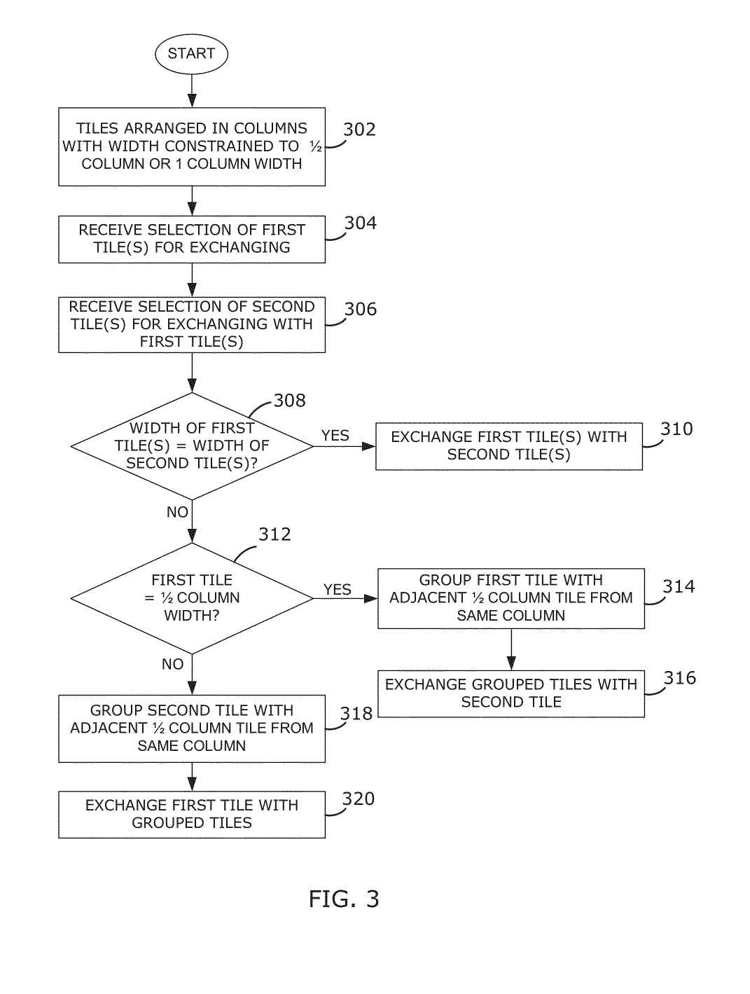

A flowchart illustrating a method of controlling display of information on an electronic device is shown in FIG. 3. The method may be carried out by software executed, for example, by the processor 102. Coding of software for carrying out such a method is within the scope of a person of ordinary skill in the art given the present description. The method may contain additional or fewer processes than shown and/or described, and may be performed in a different order. Computer-readable code executable by at least one processor 102 of the electronic device to perform the method may be stored in a computer-readable storage medium, such as a non-transitory computer-readable medium.

Information is displayed in tiles that are arranged in columns at 302 on the touch-sensitive display 118. The width of each of the tiles is based on the width of the columns and is constrained such that each tile has a width that is either equal to about one half a column width or equal to about one column width. For each tile that is about one half column width, another tile of about one half column width is disposed adjacent and in the same column. The tiles that are about one half the column width, for example, may be slightly smaller than one half the column width to provide a relatively small space between adjacent tiles in the same column.

As stated, in the present example, the displayed height of the tiles that are about one half column width is constrained to one unit in height. The displayed height of the remaining tiles is constrained to any one of one unit in height, two units in height, or three units in height.

A selection of a first tile or tiles, referred to herein as the first selected tile, from a first location is received at the electronic device at 304. The first selected tile may be a selection of a single tile or a selection of two adjacent tiles from a column, which may be any column of displayed tiles. Thus, the first selected tile may include one or two tiles from a single column. The first selected tile may be selected by a touch event on the touch-sensitive display 118. The touch event may be a single touch or a multi-touch event in which two fingers touch the touch-sensitive display 118 at the same or about the same time, for example, to select multiple tiles. Alternatively, the first selected tile may be selected utilizing a navigation device to control a navigation indicator, such as a cursor or highlighter. Suitable navigation devices may include, for example, a track pad, an optical joystick, a mouse, a scroll wheel or ball or any other suitable navigation device.

A selection of a second tile or tiles, referred to herein as the second selected tile, from a second location is received at the electronic device at 306. The second selected tile may be a selection of a single tile or a selection of two adjacent tiles from a column, which may be the same column from which the first selected tile was selected or may be a different column. Thus, the second selected tile may include one or two tiles from a single column. The second selected tile may be selected by a touch event on the touch-sensitive display 118. The second selected tile may be selected by, for example, a dragging operation in which the touch event utilized to select the first selected tile at 304 is dragged to another column or to another location in the same column and the tile or tiles associated with the end location of the touch event are selected. In this example, the tile or tiles displayed at the end location or locations of the touch event are the second selected tile for exchanging with the first selected tile. Alternatively, the second selected tile may be selected by a separate single touch or multi-touch event, or utilizing a navigation device.

The width of the first selected tile is compared with the width of the second selected tile to determine if the width of the first selected tile is equal to the width of the second selected tile 308. In response to determining that the width of the first selected tile is equal to the width of the second selected tile at 308, the process continues at 310 and the first selected tile and the second selected tile are exchanged at 310. The first selected tile and the second selected tile are exchanged by moving the first selected tile from the first location, from which the first selected tile was selected, to the second location, from which the second selected tile was selected. The second selected tile is moved from the second location, from which the second selected tile was selected, to the first location, from which the first selected tile was selected. Thus, the first selected tile and the second selected tile are moved to exchange places either within one column, i.e., the first selected tile and second selected tile are selected from the same column, or in different columns.

The height of the first selected tile and the height of the second selected tile may differ. When the first selected tile and second selected tile are exchanged, the remaining tiles in a column may be shifted up or down within the column to accommodate the exchanged tiles of different height. For example, when the height of the first selected tile from one column is greater than the height of the second selected tile from a second column, the tiles displayed below the first selected tile in the second column, after moving the first selected tile to the second column, are shifted down to provide sufficient space to display the first selected tile. The tiles that are displayed below the second selected tile in the first column, after moving the second selected tile to the first column, are shifted upwardly such that no large gap is left between the tiles in the column, e.g., the spacing between the tiles is generally equivalent to the spacing between other tiles in the columns.

In response to determining that the width of the first selected tile is not equal to the width of the second selected tile at 308, the process continues at 312. In response to determining that the width of the first selected tile is generally equal to about one half the column width at 312, the process continues at 314. At 314, a tile that is contiguous with the first selected tile is automatically grouped with the first selected tile. Thus, a tile that is in the same column and is immediately adjacent the first selected tile is grouped with the first selected tile. The group of tiles, including the first selected tile and the tile immediately adjacent and in the same column, has a width of about one column width.

The location of the grouped tiles, including the first selected tile and the adjacent tile from the same column as the first selected tile, are exchanged at 316 with the location of the second selected tile. The locations are exchanged by moving the grouped tiles, including the first selected tile and the adjacent tile, from the first location, from which the first selected tile was selected, to the second location, from which the second selected tile was selected. The second selected tile is moved from the second location, from which the second selected tile was selected, to the first location, from which the first selected tile was selected. Thus, the first selected tile and the adjacent tile in the same column as the first selected tile exchange locations with the second selected tile. The tiles can exchange locations within a column or may exchange locations such that the grouped tiles are moved to the column from which the second selected tile was selected and the second selected tile moves to the column from which the first selected tile was selected.

The height of the first selected tile and the height of the second selected tile or tiles may differ. When the grouped tiles and second selected tile or tiles are exchanged, the remaining tiles in a column may be shifted up or down within the column to accommodate the exchanged tiles of different height.

In response to determining that that the width of the first selected tile is not generally equal to about one half the column width at 312, the process continues at 318. Thus, when the width of the first selected tile is not equal to the width of the second selected tile and the first selected tile is not equal to one half the column width, the second selected tile is the smaller tile and is therefore equal to one half the column width.

At 318, a tile that is contiguous with the second selected tile is automatically grouped with the second selected tile. Thus, a tile that is in the same column and is immediately adjacent the second selected tile is grouped with the second selected tile. The grouped tiles, including the second selected tile and the tile immediately adjacent and in the same column, have a width of about one column width.

The location of the grouped tiles, including the second selected tile and the adjacent tile from the same column as the second selected tile, are exchanged at 320 with the location of the first selected tile. The locations are exchanged by moving the grouped tiles, including the second selected tile and the adjacent tile, from the second location, from which the second selected tile was selected, to the first location, from which the first selected tile was selected. The first selected tile is moved from the first location, from which the first selected tile was selected, to the second location, from which the second selected tile was selected. Thus, the first selected tile exchanges locations with the second selected tile and the adjacent tile in the same column as the second selected tile. The tiles can exchange locations within a column when the first selected tile and second selected tile are from the same column, or may exchange locations such that the grouped tiles are moved to the column from which the first selected tile was selected and the first selected tile moves to the column from which the second selected tile was selected.

The height of the first selected tile and the height of the second selected tile may differ. When the grouped tiles and the first selected tile are exchanged, the remaining tiles in a column may be shifted up or down within the column to accommodate the exchanged tiles of different height.

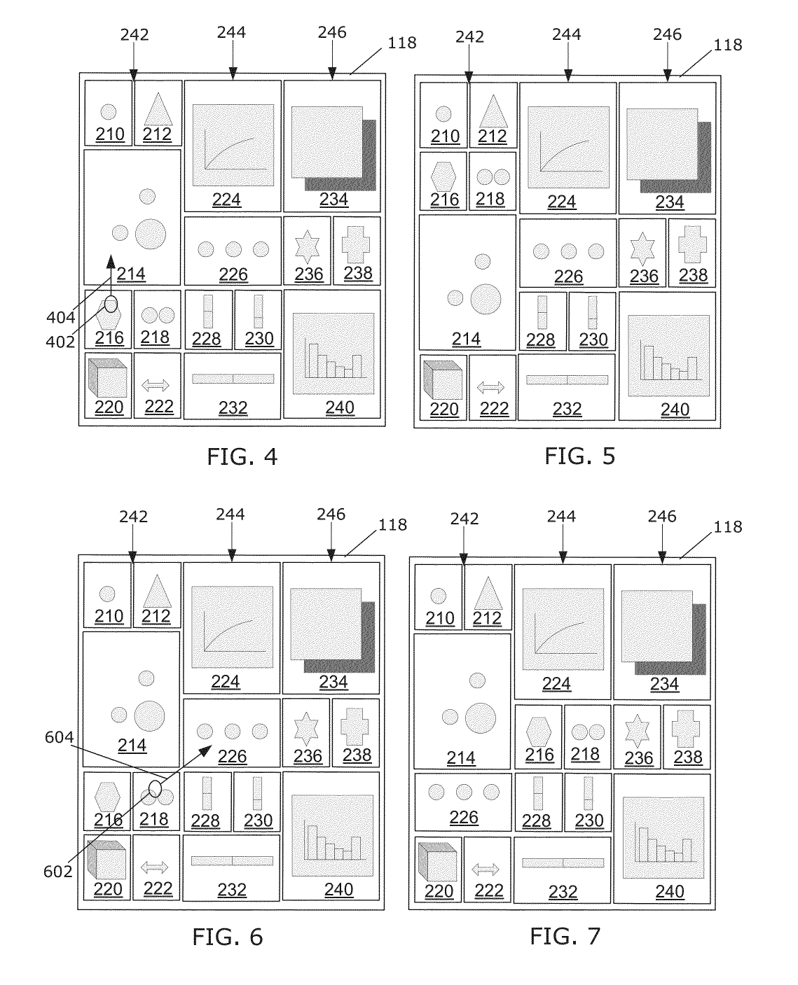

Examples of displayed information and control of the displayed information are shown in FIG. 4 through FIG. 11. In the examples of FIG. 4 through FIG. 9, the touch-sensitive display 118 and the 16 tiles 210, 212, 214, 216, 218, 220, 222, 224, 226, 228, 230, 232, 234, 236, 238, 240 illustrated in FIG. 2 are shown.

As described above with reference to FIG. 2, the tiles are arranged in columns. In this example, three columns 242, 244, 246 of tiles are displayed. The left column 242 includes 7 tiles 210, 212, 214, 216, 218, 220, 222. The middle column 244 includes five tiles 224, 226, 228, 230, 232 and the right column 246 includes four tiles 234, 236, 238, 240. Each column has an associated column width. Other numbers of columns and other numbers of tiles may be successfully implemented.

The width of each of the tiles is based on the width of the columns and is constrained such that each tile has a width that is either equal to about one half a column width or is equal to about one column width. Thus tiles may have a width of about the column width or a width of about one half the column width. For each tile that is about one half column width, such as the tile 210, another tile of about one half column width is disposed adjacent and in the same column, such as the tile 212.

In the example of FIG. 4 and FIG. 5, a touch and drag is detected on the touch-sensitive display 118. The touch is illustrated by the ellipse 402 and the dragging motion is illustrated by the arrow 404 in FIG. 4. The touch ends at the end of the arrow 404. The touch begins on the tile 216, selecting the first tile 216 for exchanging at 304. The touch ends on the tile 214, selecting the tile 214 for exchanging with the first selected tile 216 at 306. The width of the first selected tile 216, which is about one half the column width, is not equal to the width of the second selected tile 214, which is about one column width. The process continues from 308 to 312, where the first selected tile 216 is determined to be one half the column width and the process continues at 314.

The tile 218 that is contiguous with the first selected tile 216 is automatically grouped with the first selected tile 216 at 314. Thus, the tile 218, which is in the same column 242, and is immediately adjacent the first selected tile 216 is grouped with the first selected tile 216. The group of tiles, including the first selected tile 216 and the tile immediately adjacent 218 and in the same column 242, has a width of about one column width.

The location of the grouped tiles, including the first selected tile 216 and the adjacent tile 218 from the same column 242 as the first selected tile 216, are exchanged with the location of the second selected tile 214 at 316 such that the order of tiles in the left column 242 changes, as shown in FIG. 5.

The height of the first selected tile 216 and the height of the second selected tile 214 differ. However, because the first selected tile 216 and the second selected tile 214 are vertically adjacent in the left column 242, the locations of the remaining tiles in the left column 242 are unaffected by the change in location of the first selected tile 216 and the adjacent tile 218 with the location of the second selected tile 214.

Referring now to the example of FIG. 6 and FIG. 7, a touch and drag is detected on the touch-sensitive display 118. The touch is illustrated by the ellipse 602 and the dragging motion is illustrated by the arrow 604 in FIG. 6. The touch ends at the end of the arrow 604. The touch begins on the tile 218, selecting the first tile 218 for exchanging at 304. The touch ends on the tile 226, selecting the second tile 226 for exchanging with the first selected tile 218 at 306. The width of the first selected tile 218, which is about one half the column width, is not equal to the width of the second selected tile 226, which is about one column width. The process continues from 308 to 312, where the first selected tile 218 is determined to be one half the column width and the process continues at 314.

The tile 216 that is contiguous with the first selected tile 218 is automatically grouped with the first selected tile 218 at 314. Thus, the tile 216, which is in the same column 242 as the first selected tile 218, and is immediately adjacent the first selected tile 218 is grouped with the first selected tile 218. The group of tiles, including the first selected tile 218 and the tile 216 that is immediately adjacent and in the same column 242, has a width of about one column width.

The location of the grouped tiles, including the first selected tile 218 and the adjacent tile 216 from the same column 240 as the first selected tile 218, are exchanged with the location of the second selected tile 226 at 316 such that tiles 218 and 216 are moved to the middle column 242 and the tile 226 is moved to the left column 240, as shown in FIG. 7.

The height of the first selected tile 218 and the height of the second selected tile 226 is the same. In particular, the second selected tile 226 and the first selected tile 218 both have a height of one unit. When the tiles exchange locations at 316, the tiles 220, 222 that were displayed underneath the first selected tile 218 and the adjacent tile 216 in FIG. 6, are not moved as their locations remain unchanged. The tiles 228, 230 that were displayed underneath the second selected tile 226 in FIG. 6 are also not moved as their locations remain unchanged.

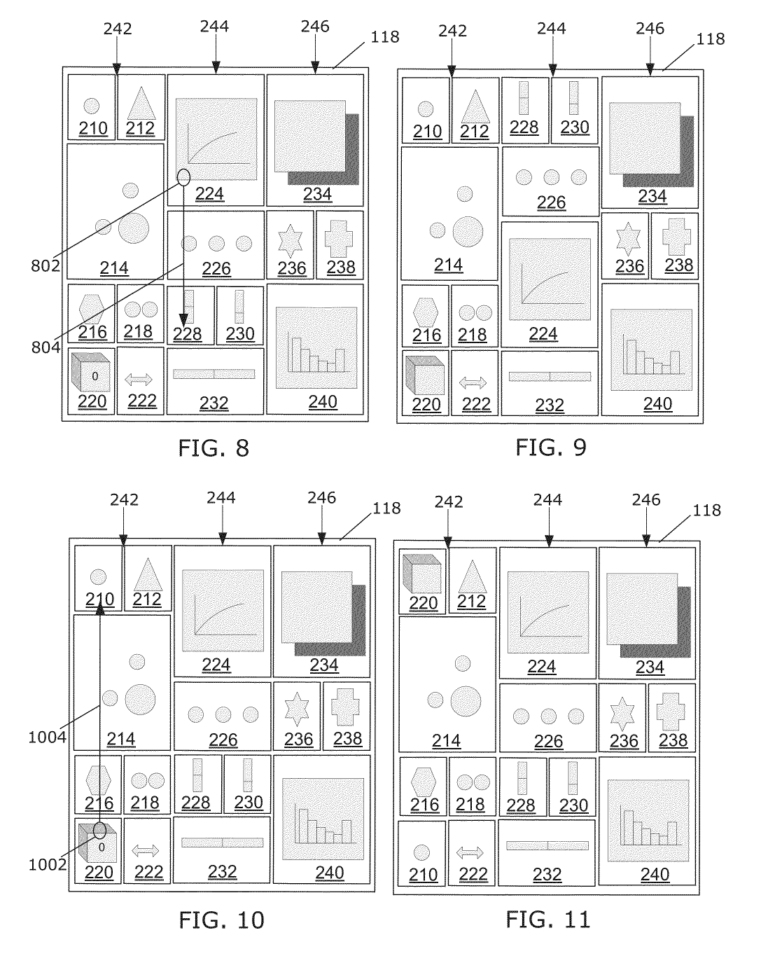

In the example of FIG. 8 and FIG. 9, a touch and drag is detected on the touch-sensitive display 118. The touch is illustrated by the ellipse 802 and the dragging motion is illustrated by the arrow 804 in FIG. 8. The touch ends at the end of the arrow 804. The touch begins on the tile 224, selecting the first tile 224 for exchanging at 304. The touch ends on the tile 228, selecting the tile 228 for exchanging with the tile 224 at 306. The width of the first selected tile 224, which is about one column width, is not equal to the width of the second selected tile 228, which is about one half the column width. The process continues from 308 to 312, where the first selected tile is determined not to be one half the column width and the process continues at 318.

The tile 230 that is contiguous with the second selected tile 228 is automatically grouped with the second selected tile 228 at 314. Thus, the tile 230, which is in the same column 244, and is immediately adjacent the second selected tile 228 is grouped with the second selected tile 228. The group of tiles, including the second selected tile 228 and the tile immediately adjacent 230 and in the same column 242, has a width of about one column width.

The location of the first selected tile 224 is exchanged with the location of the grouped tiles, which includes the second selected tile 228 and the adjacent tile 230 in the same column, which is the middle column 244, as shown in FIG. 9.

The height of the first selected tile 224 and the height of the second selected tile 228 are not equal. In particular, the height of the first selected tile 224 is two units in height and the height of the second selected tile 228 is one unit in height. Thus, the location of the tile 226 that is disposed between the tile 224 and the tile 228 in the same column 244, is changed. The tile 226 moves up in the column when the tiles 228 and 230 exchange locations with the tile 224.

Referring now to FIG. 10 and FIG. 11, a touch and drag is detected on the touch-sensitive display 118. The touch is illustrated by the ellipse 1002 and the dragging motion is illustrated by the arrow 1004 in FIG. 10. The touch ends at the end of the arrow 1004. The touch begins on the tile 220, selecting the first tile 220 for exchanging at 304. The touch ends on the tile 210, selecting the tile 210 for exchanging with the first selected tile 220 at 306. The width of the second selected tile 220, which is about one half the column width, is equal to the width of the first selected tile 210, which is equal to about one half the column width. The process continues from 308 to 310, where the location of the first selected tile 220 is exchanged with the location of the second selected tile 210, as shown in FIG. 11.

The height of the first selected tile 220 and the height of the second selected tile 210 is generally equal and thus, the remaining tiles in the left column 242 are unaffected by the change in locations.

In the above examples, the displayed height of the tiles that are about one half column width is constrained to one unit in height. Alternatively, the displayed height of the tiles may be constrained to any whole number of units. For example, the displayed height of the tiles may be constrained such that each tile that is one half column width is one unit in height, two units in height, or three units in height. Thus, the displayed height of the tiles that are one half column width may not all be the same.

In this alternative example, in addition to comparing the width of the first selected tile and the second selected tile at 308, the height of the first selected tile may be compared with the height of the second selected tile when the first selected tile and the second selected tile are both one half column width, to determine if the height of the first selected tile is equal to the height of the second selected tile. In response to determining that the height of the first selected tile is equal to the height of the selected tile, the first selected tile and the second selected tile are exchanged. In response to determining that the height of the first selected tile is not equal to the height of the second selected tile, additional tiles may be grouped such that a one half column width tile of one unit height, for example, is not exchanged for a one half column width tile of two units in height, leaving a large gap or large space between tiles, compared the spaces between tiles before the tile locations are exchanged.

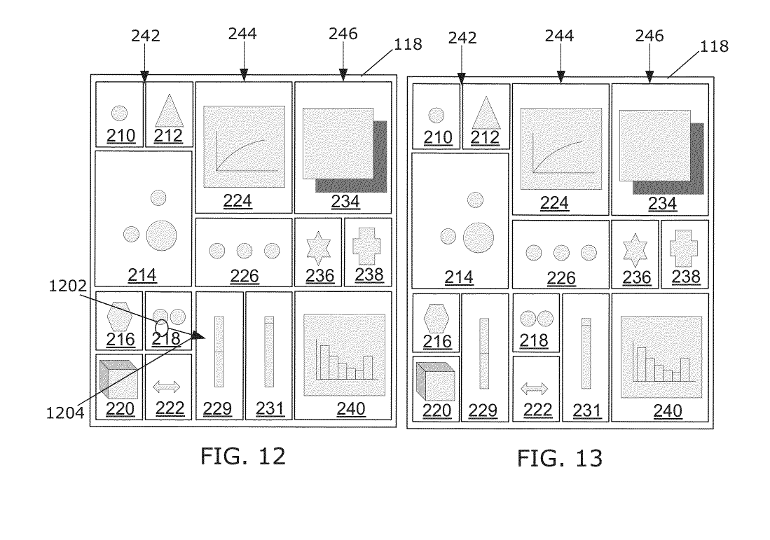

An example of such an alternative is shown in FIG. 12 and FIG. 13. In this example, the tiles 229 and 231 in the middle column 244 are one half column width tiles that are two units in height. A touch and drag is detected on the touch-sensitive display 118. The touch is illustrated by the ellipse 1202 and the dragging motion is illustrated by the arrow 1204 in FIG. 12. The touch ends at the end of the arrow 1204. The touch begins on the tile 218, selecting the first tile 218 for exchanging. The touch ends on the tile 229, selecting the tile 229 for exchanging with the first selected tile 218. The width of the second selected tile 229, which is about one half the column width, is equal to the width of the first selected tile 218, which is equal to about one half the column width. In this example, however, the height of the second selected tile 229 is two units while the height of the first selected tile 218 is one unit. Thus, the height of the second selected tile 229 is not equal to the height of the first selected tile 218. A tile that is contiguous with the first selected tile 218 is grouped with the first selected tile. The tile that is contiguous may be selected by selecting a tile below the first selected tile 218 or above the first selected tile 218. For the purpose of the example of FIG. 12, a one half column width tile 222 that is also one unit in height is disposed immediately below the first selected tile 218 and thus, the one half column width tile 222 is grouped with the first selected tile 218 for exchange with the second selected tile 229, as illustrated in FIG. 13.

Alternatively, adjacent tiles may be grouped such that the tile 216 beside the tile 218 and in the same column 242 may grouped and the tile 231 beside the tile 229 and in the same column 244 may be grouped. Thus, the tiles 216, 218 exchange locations with the tiles 229, 231.

In the examples described herein, the tiles are selected based on touches on the touch-sensitive display. Multi-touch drag and drop gestures may also be utilized to select multiple tiles. Alternatively, tiles may be selected utilizing a track pad, optical joystick, trackball, mouse, or other device to move a navigation indicator such as a cursor or highlighting on the display to select the tiles.

Advantageously, tiles are arranged in columns of equal width and the width of the tiles is set to be generally equal to a column width or about one half the column width. Tiles that are generally equal to one half the column width are adjacent other tiles that are generally equal to about one half the column width and are displayed in the same column. When a tile of about one half the column width is selected for exchange with a tile that is about one column width, the selected tile that is about one half the column width is grouped with the adjacent one half column width tile from the same column. The grouped tiles then exchange locations with the selected tile that is about one column width. As a result, no large spaces, relative to the spaces between other tiles, are left between the tiles after the exchange.

The scope of the claims should not be limited by the preferred embodiments set forth in the examples, but should be given the broadest interpretation consistent with the description as a whole.

What is claimed is:

1. A method of controlling display of information in tiles on an electronic device, the method comprising:
arranging the tiles in a plurality of columns, each of the tiles having a width of about a column width or about one half the column width;
receiving a selection of a first tile at a first location and receiving a selection of a second tile at a second location;
in response to determining that a first tile width is generally equal to a second tile width, exchanging the first tile with the second tile such that the first tile is moved generally to the second location and the second tile is moved generally to the first location;
in response to determining that the first tile width is not equal to the second tile width and the first tile width is equal to about one half the column width:
grouping the first tile with a first adjacent tile from a first adjacent location in a same one of the plurality of columns as the first tile; and
exchanging the grouped first tile and first adjacent tile with the second tile by moving the first tile and the first adjacent tile generally to the second location and the second tile generally to the first location and the first adjacent location;
in response to determining that the first tile width is not equal to the second tile width and the second tile width is equal to about one half the column width:
grouping the second tile with a second adjacent tile from a second adjacent location in a same one of the plurality of columns as the second tile; and
exchanging the first tile with the grouped second tile and the second adjacent tile by moving the first tile generally to the second location and the second adjacent location and moving the second tile and second adjacent tile generally to the first location.

2. The method according to claim 1, wherein exchanging the first tile with the second tile comprises moving other tiles in at least one of the columns to accommodate a difference in height of the first tile and height of the second tile.

3. The method according to claim 1, wherein exchanging the grouped first tile and first adjacent tile with the second tile comprises moving other tiles in at least one of the columns to accommodate a difference in height of the first tile and height of the second tile.

4. The method according to claim 1, wherein exchanging the first tile with the grouped second tile and second adjacent tile comprises moving other tiles in at least one of the columns to accommodate a difference in height of the first tile and height of the second tile.

5. The method according to claim 1, wherein receiving the selection of the first tile comprises receiving a selection of the first tile and the adjacent first tile.

6. The method according to claim 1, wherein receiving the selection of the second tile comprises receiving the selection of the second tile and the adjacent second tile.

7. The method according to claim 1, wherein the information comprises at least one of icons and widgets.

8. The method according to claim 1, wherein the first tile is in a first column and the second tile is in a second column such that the first tile is moved to the second column and the second tile is moved to the first column.

9. The method according to claim 1, wherein arranging the tiles in a plurality of columns comprises arranging the tiles such that none of the tiles are disposed in more than one column.

10. A non-transitory computer-readable storage medium having computer-readable code executable by at least one processor of the portable electronic device to perform the method according to claim 1.

11. An electronic device comprising:
a display for displaying information arranged in tiles;
a control device for selecting groups of tiles;
a processor coupled to the display and to the control device and programmed to:
arrange the tiles in a plurality of columns, each of the tiles having a width of about a column width or about one half the column width;
receive a selection of a first tile at a first location and receive a selection of a second tile at a second location;
in response to determining that a first tile width is generally equal to a second tile width, exchange the first tile with the second tile such that the first tile is moved generally to the second location and the second tile is moved generally to the first location;
in response to determining that the first tile width is not equal to the second tile width and the first tile width is equal to about one half the column width:
group the first tile with a first adjacent tile from a first adjacent location in a same one of the plurality of columns as the first tile; and
exchange the grouped first tile and first adjacent tile with the second tile by moving the first tile and the first adjacent tile generally to the second location and the second tile generally to the first location and the first adjacent location;
in response to determining that the first tile width is not equal to the second tile width and the second tile width is equal to about one half the column width:
group the second tile with a second adjacent tile from a second adjacent location in a same one of the plurality of columns as the second tile; and
exchange the first tile with the grouped second tile and the second adjacent tile by moving the first tile generally to the second location and the second adjacent location and moving the second tile and second adjacent tile generally to the first location.

12. The electronic device according to claim 11, wherein the display is part of a touch-sensitive display and the control device comprises touch sensors of the touch-sensitive display.

13. The electronic device according to claim 11, wherein other tiles in at least one of the columns are moved to accommodate differences in height of the first tile and height of the second tile.

14. The electronic device according to claim 11, wherein the selection of the first tile comprises a selection of the first tile and the adjacent first tile.

15. The electronic device according to claim 11, wherein the selection of the second tile comprises a selection of the second tile and the adjacent second tile.

16. The electronic device according to claim 11, wherein the information comprises at least one of icons and widgets.

17. The electronic device according to claim 11, wherein the first tile is in a first column and the second tile is in a second column such that the first tile is moved to the second column and the second tile is moved to the first column.

18. The electronic device according to claim 11, wherein the tiles are arranged in the plurality of columns such that none of the tiles are disposed in more than one column.
